(19) United States
(12) Patent Application Publication
(10) Pub. No.: US 2003/0227562 A1
(43) Pub. Date: Dec. 11, 2003

(54) MULTISHOT CAMERA

(75) Inventors: Martin Philip Gouch, Herts (GB); Nigel Ingram Bromley, Bucks (GB)

Correspondence Address: SUGHRUE MION, PLLC, 1010 EL CAMINO REAL, SUITE 300, MENLO PARK, CA, 94025, US

(73) Assignee: FUJIFILM ELECTRONIC IMAGING LIMITED, Herts (GB)

(21) Appl. No.: 10/170,782

(22) Filed: Jun. 11, 2002

(51) Int. Cl. H04N 5/232

(52) U.S. Cl. 348/345

(57) ABSTRACT

A digital imaging device has a CCD array fixed to a housing. A focussing lens is mounted via a mounting assembly to the housing to focus an image onto the detector array. The mounting assembly is operable to move the lens relative to the housing and detector array whereby the image can be displaced relative to the detector array.

### FIELD OF THE INVENTION

The invention relates to a digital imaging device such as a digital camera.

When using colour digital cameras with two dimensional detector chips the resolution is lower than the equivalent mono detector chip. This is because the colour detector has to use three pixel sites for each output pixel, one red pixel, one green pixel and one blue pixel. Thus the actual resolution of the colour detector is three times lower than the equivalent mono detector. Consider a simple system where the colour detector has rows of red, green and blue pixels. Many manufacturers use complicated schemes to improve the resolution of the green channel at the expense of the blue or to reduce colour aliasing but some manufacturers simply have a row of red pixels, row of green pixels, row of blue pixels repeated throughout the entire chip.

This drop in resolution can lead to unwanted artefacts in an image called colour aliasing where the edges of diagonal neutral lines have a continuously varying rainbow of colours.

Thus for example a 3000×3000=9M mono chip will only produce 1000×3000=3M colour pixels.

On some digital camera backs it is possible to take three exposures with the CCD chip displaced by one row at a time. Then the image is reassembled to produce a single colour image with the same resolution as the equivalent mono chip because each possible pixel position would have had a red, green and blue pixel sensor in one of the exposures.

This is well known and a solution is provided by many camera back manufacturers such as Kodak and Creo. With a more complicated scheme for interlacing the red green and blue pixels such as having more pixels one colour than another it will be necessary to have more than three exposures to create one full resolution image. Also it may be necessary to have more than one direction of displacement to create a full resolution image if the pixels of one colour are spaced many pixels apart in one direction.

This simple displacement of the CCD chip has to be built into the camera back or into the camera itself. It is not possible to do this once the CCD has been mounted securely in a camera.

In accordance with a first aspect of the present invention, we provide a digital imaging device having a detector array fixed to a housing, the detector array including a set of radiation detectors responsive to radiation of different wavelengths; and a focusing lens, mounted via a mounting assembly to the housing, to focus an image onto the detector array, wherein the mounting assembly is operable to move the lens relative to the housing and detector array whereby the image can be displaced relative to the detector array.

With this invention, instead of moving the detector array relative to the lens, the lens is mounted so as to be displaceable relative to the detector array. Typically, this will be displacement in a single direction although in some cases displacement in more than one direction is feasible. This enables a colour 2D detector to have the same resolution as the equivalent mono 2D detector when successive exposures, typically three, are recombined.

Although the mounting assembly could be manually operable, preferably the mounting assembly is electrically operable and for example comprises a piezoelectric device.

In some cases, digital imaging devices have a focussing lens which is fixed to the housing and thus the approach set out above is not possible.

We therefore provide in accordance with a second aspect of the present invention, a digital imaging device having a detector array fixed to a housing, the detector array including a set of radiation detectors responsive to radiation of different wavelengths; and a focussing lens fixed to the housing to focus an image onto the detector array; and a mounting assembly for connecting the housing to a support, the mounting assembly being operable to tilt the housing relative to the support so as to cause the image to be displaced relative to the detector array. Once again, this tilting movement about at least one and possibly more axes enables a colour 2D detector to have the same resolution as the equivalent mono 2D detector following successive, typically three, exposures which are then recombined.

In both cases, a calibration process can be carried out where one or more of the magnitude, direction of the displacement, and frequency of the displacement required can be measured from a calibration chart.

The detector array is typically a CCD array and this may have any conventional form. In one example, the detectors are arranged in substantially parallel rows, each member of a row being sensitive to the same wavelength while members of adjacent rows are sensitive to different wavelengths. Typically, the wavelengths are red, green and blue.

In other examples, each row may include a detector sensitive to more than one wavelength.

### BRIEF DESCRIPTION OF THE DRAWINGS

Some examples of digital imaging devices according to the invention will now be described with reference to the accompanying drawings, in which:—

FIG. 1 is an exploded, schematic side elevation of a first embodiment;

FIG. 2 is a schematic side elevation of the first embodiment after assembly;

FIG. 3 illustrates graphically the variation of image displacement at the detector array with object distance;

FIG. 4 is a schematic, side elevation of a second embodiment of the invention;

FIG. 5 illustrates graphically image displacement at the detector array with object to lens distance for the second embodiment;

FIG. 6 illustrates graphically the variation of displacement at the detector array with object height; and,

FIG. 7 illustrates part of a typical detector array.

### DESCRIPTION OF THE EMBODIMENTS

First Preferred Embodiment

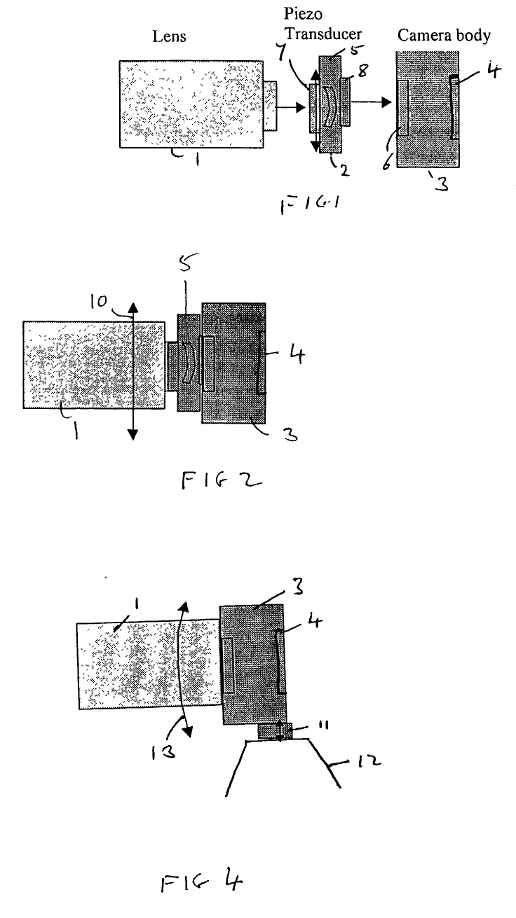

For many cameras such as the FujiFilm S1 and S2 the lens is mountable with either a standard bayonet or standard screw thread. In the first embodiment (FIG. 1) a focussing lens 1 is mounted via a mounting assembly or interface plate 2 to a camera body 3. A 2D CCD array 4 is mounted to the back of the housing 3. FIG. 7 illustrates a typical CCD array 4 made up of a set of three repeated rows 21-23. Each row includes a large number of pixel detectors, the detectors in the row 21 being sensitive to red light, those in the row 22 being sensitive to green light and those in the row 23 being sensitive to blue light.

In this case, rather than move the CCD 4 relative to the lens 1 it is possible to move the lens relative to the CCD. To achieve this, the interface plate 2 is mounted via a mount 8 into the camera body 3 in the standard bayonet or screw thread 6 and provides a similar mount 7 for the lens 1. A piezo transducer 5 in between creates a shear displacement between these two mounts 7, 8, which simulates the CCD displacement described in the prior art. A relay lens 9 in this device is also important to enable the main lens 1 to focus at infinity.

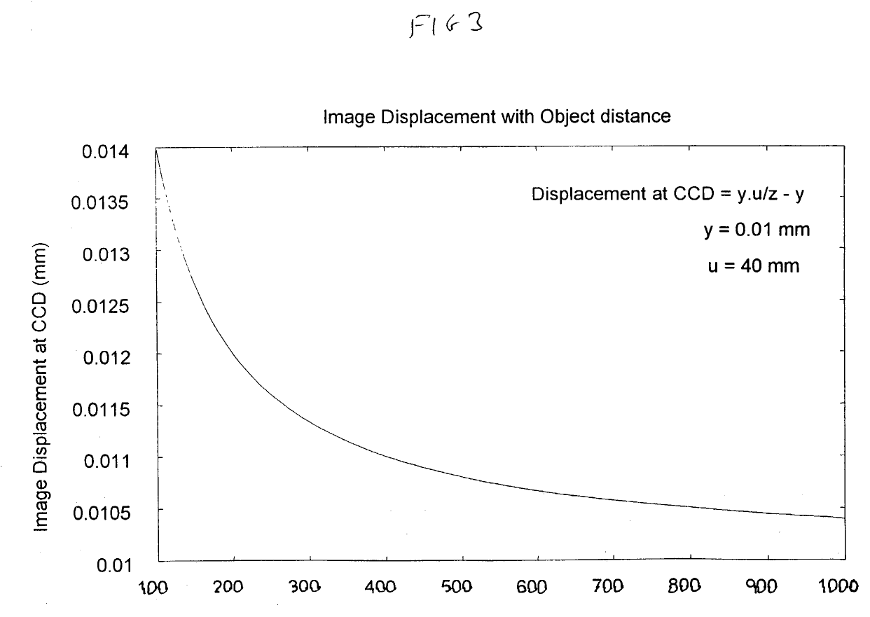

FIG. 2 shows the assembled item with moving direction indicated by arrow 10.

This would give the following displacement based upon simple lens equations.

$$Δ i = \frac{y \cdot u}{z} - y$$

where

i=height of image at CCD

y=displacement of lens

u=distance between lens and CCD

z=distance between lens and object

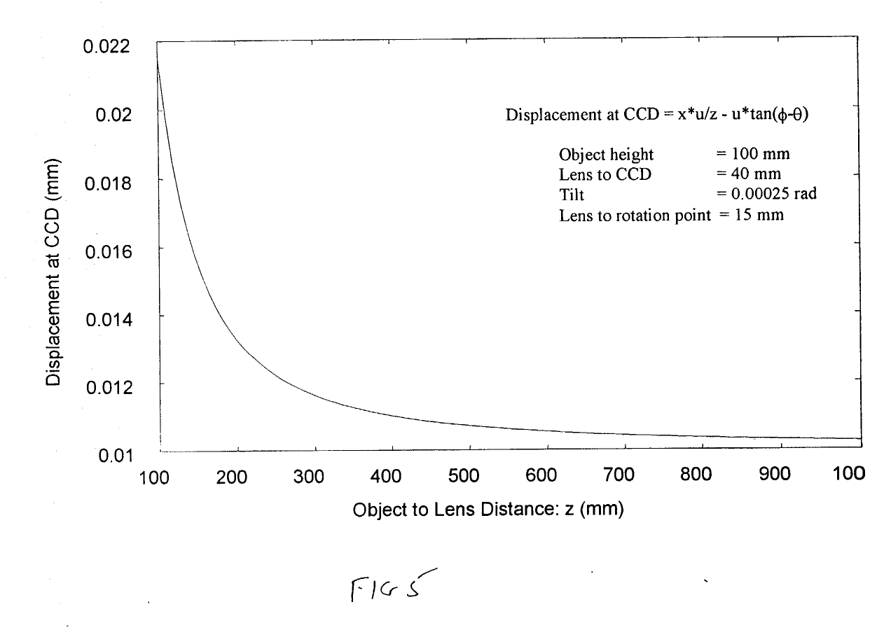

The equation is not ideal in that there is a relationship of the distance between the lens and the object, z, and the amount of movement of the image on the CCD, Δi. The advantage is that for small displacements of the lens, y, and large distances of the object this relationship is weak and dominated by the second term of the equation, displacement of the lens, y. (FIG. 3)

As errors of less than 0.001 in 0.01 are acceptable then clearly for lens to CCD distances of 40 mm once the objects are more than 400 mm away this relationship is not a problem and can be ignored. These are typical examples for a digital camera set-up.

Clearly depending upon the arrangement of the red, green and blue pixels it may be necessary to have more than one direction of movement but the equations will operate in both axes. Also like the prior art it may be necessary to have more than three exposures to create a full resolution colour image.

Second preferred embodiment

For many cameras such as the FujiFilm 4900 the lens 1 is an integral part of the camera body 3 (FIG. 4). Thus the first preferred embodiment would not work. To achieve the same effect though the camera needs to be tilted. Thus rather than move the CCD 4 relative to the lens 1 it is possible to move the image over the CCD 4. To achieve this, an interface plate 11 is mounted between the camera body 4 and a tripod 12. In between a rotational displacement 13 is created with a piezo transducer (not shown), which simulates the CCD displacement described in the prior art.

In this situation the equations are slightly more complex

$$\begin{matrix}Δ i = \frac{h \cdot u}{z} - u \cdot tan ( φ - θ ) \\ tan ( φ ) = \frac{h - r \cdot sin θ}{z + r ( 1 - cos θ )}\end{matrix}$$

where

i=height of image at CCD

u=distance between lens and CCD

z=distance between lens and object

θ=rotation of the camera and lens

r=distance from the lens to the rotational axis

h=height of object

This leaves the height of the object as a variable in the equation but in certain circumstances this need not be a problem.

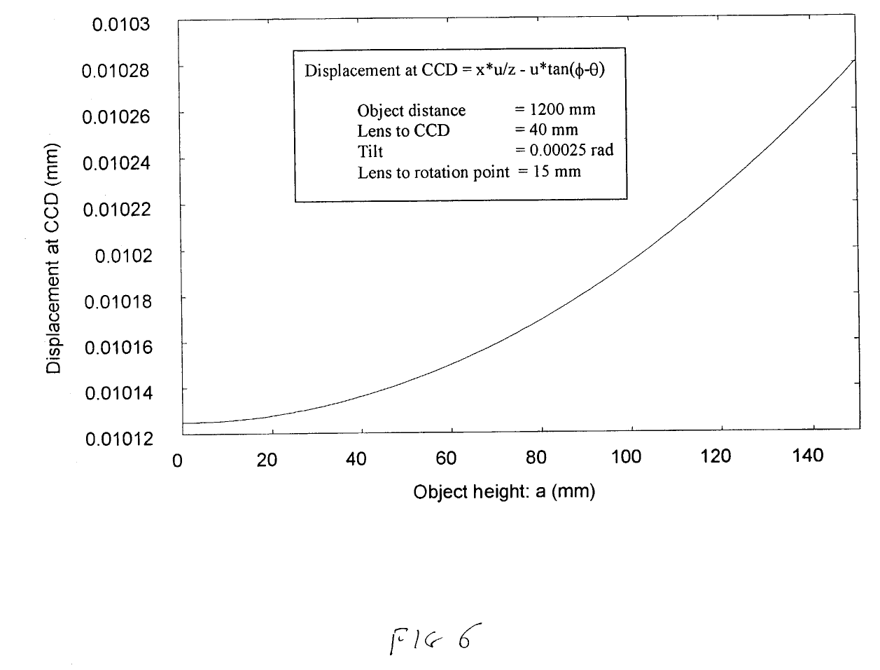

As in the first embodiment the displacement also varies with distance of the object from the lens, z, but over a certain distance this variation is small enough to be ignored. (FIG. 5)

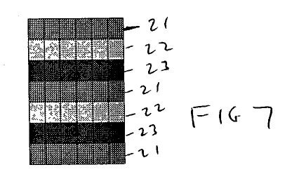

Also as the size of CCD's is small the magnitude of the height of the object is limited which limits the variation in displacement of the image. (FIG. 6)

Clearly for every lens and camera body and rotation point the magnitude of the rotation needs to be different so it is desirable to calibrate this embodiment with a test chart where the effects of the rotation can be measured prior to taking the picture and the correct rotation calculated.

Similarly to the first embodiment, depending upon the arrangement of the red, green and blue pixels it may be necessary to have more than one direction of movement but the equations will operate in both axis. Also like the prior art it may be necessary to have more than three exposures to create a full resolution colour image.

We claim:—

1. A digital imaging device having a detector array fixed to a housing, the detector array including a set of radiation detectors responsive to radiation of different wavelengths; and a focussing lens, mounted via a mounting assembly to the housing, to focus an image onto the detector array, wherein the mounting assembly is operable to move the lens relative to the housing and detector array whereby the image can be displaced relative to the detector array.

2. A device according to claim 1, wherein the mounting assembly includes a relay lens to enable the focussing lens to focus at infinity.

3. A device according to claim 1, wherein the mounting assembly is electrically operable.

4. A device according to claim 3, wherein the mounting assembly includes a piezoelectric device or other movement device.

5. A device according to claim 1, wherein the detector array comprises a CCD array.

6. A device according to claim 1, wherein the detectors are arranged in substantially parallel rows, each member of a row being sensitive to the same wavelength and members of adjacent rows being sensitive to different wavelengths.

7. A device according to claim 1, wherein different detectors are sensitive to red, green and blue light respectively.

8. A digital imaging device having a detector array fixed to a housing, the detector array including a set of radiation detectors responsive to radiation of different wavelengths; and a focussing lens fixed to the housing to focus an image onto the detector array; and a mounting assembly for connecting the housing to a support, the mounting assembly being operable to tilt the housing relative to the support so as to cause the image to be displaced relative to the detector array.

9. A device according to claim 8, wherein the mounting assembly is electrically operable.

10. A device according to claim 9, wherein the mounting assembly includes a piezoelectric device or other movement device.

11. A device according to claim 8, wherein the detector array comprises a CCD array.

12. A device according to claim 8, wherein the detectors are arranged in substantially parallel rows, each member of a row being sensitive to the same wavelength and members of adjacent rows being sensitive to different wavelengths.

13. A device according to claim 8, wherein different detectors are sensitive to red, green and blue light respectively.
